(19) United States
(12) Patent Application Publication
(10) Pub. No.: US 2019/0113102 A1
(43) Pub. Date: Apr. 18, 2019

(54) INTELLIGENT CLEAN ENERGY GENERATOR

(71) Applicants: HENG-YUAN LIU, Taoyuan City (TW); YI-JUNG PENG, Taoyuan City (TW)

(72) Inventors: HENG-YUAN LIU, Taoyuan City (TW); YI-JUNG PENG, Taoyuan City (TW)

(21) Appl. No.: 15/851,722

(22) Filed: Dec. 21, 2017

(30) Foreign Application Priority Data
Oct. 17, 2017 (TW) 106135389

(51) Int. Cl. F16F 15/315; F03G 3/08; F03G 3/06

(52) U.S. Cl. CPC F16F 15/315; F03G 3/06; F03G 3/08

(57) ABSTRACT

An intelligent clean energy generator contains: a case mounted on a base and accommodating a body. The body includes an accommodation chamber and an eccentric shaft, wherein a guide structure is defined in the accommodation chamber and includes a guiding face and a groove configured to guide a rotation stein. At least one flywheel is serially connected on the eccentric shaft, and each flywheel includes multiple inertial members, each of the multiple inertial members has a seat, a coupling bolt, and the rotation stein, wherein a distance between the rotation stein and the coupling bolt of each inertial member is identical fixedly. The seat has a slide rod on which a counterweight block is disposed, each flywheel is polygonal, and the rotation stein of each inertial member is movably arranged on each of corners of each flywheel so as to match with an energy release zone.

### FIELD OF THE INVENTION

The present invention relates to an intelligent clean energy generator which has malfunction detection, alert, and report systems by way of multiple inertial members, and an energy zone of the multiple inertial members is up to 180 degrees (such as 230 degrees in an octagon shape or 240 degrees in a hexagon shape) so as to drive polygonal flywheel(s) to drive an object to rotate constantly.

### BACKGROUND OF THE INVENTION

A conventional mechanical power system contains a rotary shaft, a flywheel, and multiple inertial members. The rotary shaft is accommodated in an orifice of the flywheel, and the multiple inertial members are radially arranged outward from a center of the flywheel, wherein the flywheel is driven to rotate by hydroelectric power, wind power, motor, manpower, and animal power so as to store energy or release energy. A rotating speed of the flywheel depends on mass of each inertial member and a distance of a center of the flywheel in compliance with leverage principle. In other words, when the mass of each inertial member or the distance of the center of the flywheel is changed, the rotating speed of the flywheel is changeable. The energy stored by the flywheel is proportional to the mass of the flywheel and the square of the rotating of the flywheel, so when the rotating speed of the flywheel accelerates, the energy stored by the flywheel increases. When a rotating speed of each inertial member accelerates as storing the energy, it extends in a longest length by using a centrifugal force so as to acquire more moment of inertia, thus increasing inertial mass. When the rotating speed of each inertial member decreases as releasing the energy, each inertial member moves back to the center of the flywheel so as to lower the inertial mass, thus decreasing the rotating speed of each inertial member as storing or releasing the energy. Preferably, each inertial member keeps extending in the longest length as releasing the energy, such that each inertial member provides maximum moment of inertia in a longest time. When maximum potential energy is released, the flywheel obtains maximum kinetic energy, and rotating speeds of the flywheel and the rotary shaft are highest. When the rotary shaft is used as a central post of the power generator, electricity generated by the power generator reaches an ideal value.

Actually, each inertial member keeps extending in a longest length in a short time when releasing the energy, so it provides maximum moment of inertia in the short time. It is worse for a conventional inertial member to release potential energy by way of gravity than the above-mentioned potential energy which is released in the ideal state (i.e., maximum potential energy). Therefore, it is worse for the kinetic energy acquired by the conventional flywheel than the above-mentioned kinetic energy in the ideal state (i.e., maximum kinetic energy), hence it is obviously lower for the rotating speeds of the flywheel and the rotary shaft than the above-mentioned rotating speed (i.e., maximum rotating speed) in the ideal state. When the rotary shaft is used as the central post of the power generator, the electricity produced by the power generator is much lower than the best ideal value.

The present invention has arisen to mitigate and/or obviate the afore-described disadvantages.

### SUMMARY OF THE INVENTION

The primary aspect of the present invention is to provide an intelligent clean energy generator in which multiple inertial members release energy in an energy release zone up to 180 degrees (such as 230 degrees in an octagon shape or 240 degrees in a hexagon shape) and at least one polygonal flywheel receives largest energy to rotate at a high speed.

Secondary aspect of the present invention is to provide an intelligent clean energy generator which when a diameter of the seat is less than that of the slide rod and the counterweight is heavy duty, a start torque reaches maximum value based on leverage principle, and the seat of each inertial member is thin and the slide rod is square so as to reinforce each inertial member.

Further aspect of the present invention is to provide an intelligent clean energy generator which has the body, the at least one polygonal flywheel, the guide structure, the multiple inertial members, the infrared ray, noise, vibration, and sensor chips so as to establish malfunction detection, alert, and report systems.

To obtain above-mentioned aspects, an intelligent clean energy generator provided by the present invention contains: a body, at least one polygonal flywheel, a guide structure, a sensor chip set, and multiple inertial members.

The body includes an accommodation chamber defined by an inner wall of the body, and the body includes an eccentric shaft, wherein two zones are defined inside an upper side of the inner wall of the body in a clockwise direction along the eccentric shaft, the first zone is an energy release zone, and the second zone is an energy storage zone, a starting position is in the energy release zone, and a terminal position is in the energy storage zone.

The at least one flywheel is housed in the accommodation chamber, and the polygonal flywheel includes a first face, a second face, and a first through orifice passing through the first face and the second face and accommodating the eccentric shaft, wherein the at least one polygonal wheel is serially connected.

The guide structure includes a groove formed on the body, and the guide structure is accommodated in a case.

Each of the multiple inertial members includes a seat, a slide rod, and a counterweight block. The seat is movably arranged on the first face of the polygonal flywheel, and a channel is defined on the seat and the guide structure. The slide rod has a guiding peg sliding in the channel, and the guide peg has a first segment and a second segment. The counterweight block is disposed on a first end of the slide rod and an outer diameter of the second end of the slide rod is more than the seat, wherein the counterweight block is accommodated and slides in the seat and the channel.

The starting position of the energy release zone is the terminal position of the energy storage zone, and the terminal position of the energy release zone forms the starting position of the energy storage zone, wherein energy in the energy release zone and the energy storage zone converts into kinetic energy from potential energy.

When the at least one polygonal wheel rotates in the clockwise direction, the guide structure guides the seat of each inertial member to move toward the starting position of the energy release zone/the terminal position of the energy storage zone, and the slide rod slides in the body by using a centrifugal force, the channel of the groove supports the slide rod so that the slide rod is perpendicular to a ground at 90 degrees so as to release energy greatly.

After the counterweight contacts a lower surface of the inner wall of the body, it pushes the slide rod to move into the channel until the seat moves to the terminal position of the energy release zone/the starting position of the energy storage zone. In this period of time, each inertial member rotates clockwise, provides inertial torque, and releases potential energy by using gravity, hence the potential energy is converted into kinetic energy so as to drive the at least one polygonal flywheel to revolve in the clockwise direction, and the at least one polygonal flywheel drives the eccentric shaft to rotate clockwise.

When the at least one polygonal flywheel rotates clockwise, and the guide structure guides the seat of each inertial member to the starting position of the energy release zone/the terminal position of the energy storage zone from the terminal position of the energy release zone/the starting position of the energy storage zone, each inertial member gathers potential energy constantly.

Moreover, the starting position of the energy release zone of the al least one polygonal flywheel is the terminal position of the energy storage zone, and the terminal position of the energy release zone is the starting position of the energy storage zone, wherein an applicable energy is located in the second zone over 180 degrees, such as 230 degrees in an octagon shape or 240 degrees in a hexagon shape.

Preferably, when the eccentric shaft is a central post of the power generator, the counterweight has a stator, a rotator, and multiple coil sets, wherein the stator is a magnet of the power generator (the magnet is a permanent magnet based on power generating requirement and matches with the multiple coil sets so as to rotate the stator constantly) and is located on a center of the power generator. The multiple coil sets are arranged radially outward from the center of the power generator so as to generate double electricity.

When the multiple inertial members of the intelligent clean energy generator pass through the energy release zone, they extend in a longest length so as to provide largest moment of inertia in a long time. The potential energy is released by gravity at maximum value so as to obtain maximum kinetic energy to the at least one polygonal flywheel, hence a rotation speed of the at least one polygonal flywheel and the eccentric shaft accelerates in an ideal state (such as the energy release zone is over 180 degrees).

### BRIEF DESCRIPTION OF THE DRAWINGS

FIG. 1A is a cross sectional view showing the operation of an intelligent clean energy generator according to a first embodiment of the present invention.

FIG. 1B is a cross sectional view showing the assembly of a part of the intelligent clean energy generator according to the first embodiment of the present invention.

FIG. 2 is a perspective view showing the assembly of a part of the intelligent clean energy generator according to the first embodiment of the present invention.

FIG. 3 is a perspective view showing the operation of a part of the intelligent clean energy generator according to the first embodiment of the present invention.

FIG. 4 is another perspective view showing the operation of a part of the intelligent clean energy generator according to the first embodiment of the present invention.

FIG. 5 is a side plan view showing the assembly of a part of the intelligent clean energy generator according to the first embodiment of the present invention.

FIG. 6 is a side plan view showing the assembly of a part of the intelligent clean energy generator according to a second embodiment of the present invention.

FIG. 7 is a perspective view showing the assembly of a part of the intelligent clean energy generator according to the second embodiment of the present invention.

FIG. 8 is a block diagram showing components of the intelligent clean energy generator having sensor chips, indication, alert, and report systems respectively according to the first and second embodiments of the present invention.

### DETAILED DESCRIPTION OF THE PREFERRED EMBODIMENTS

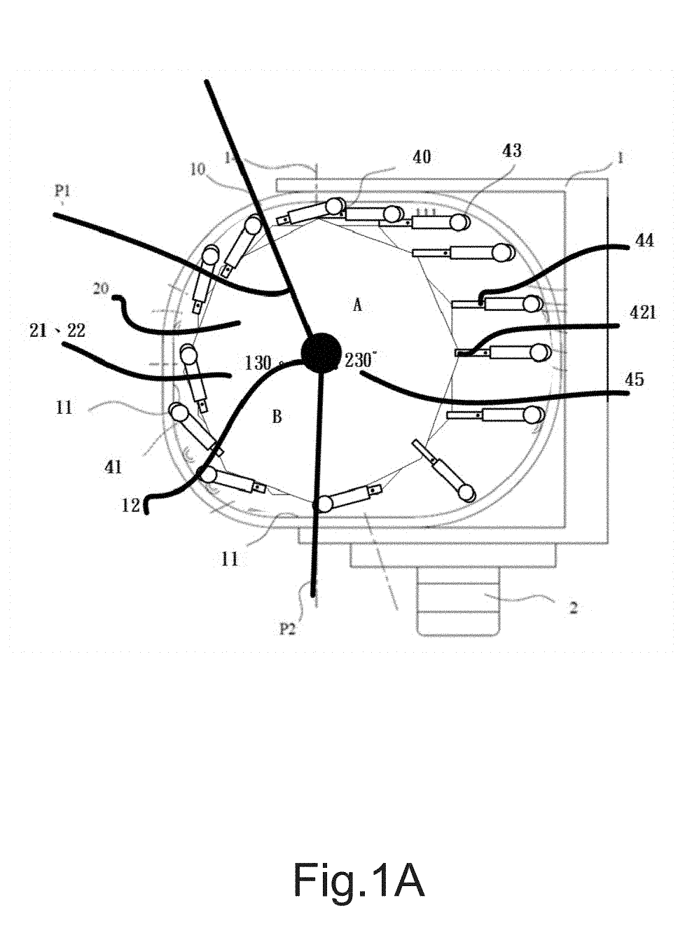

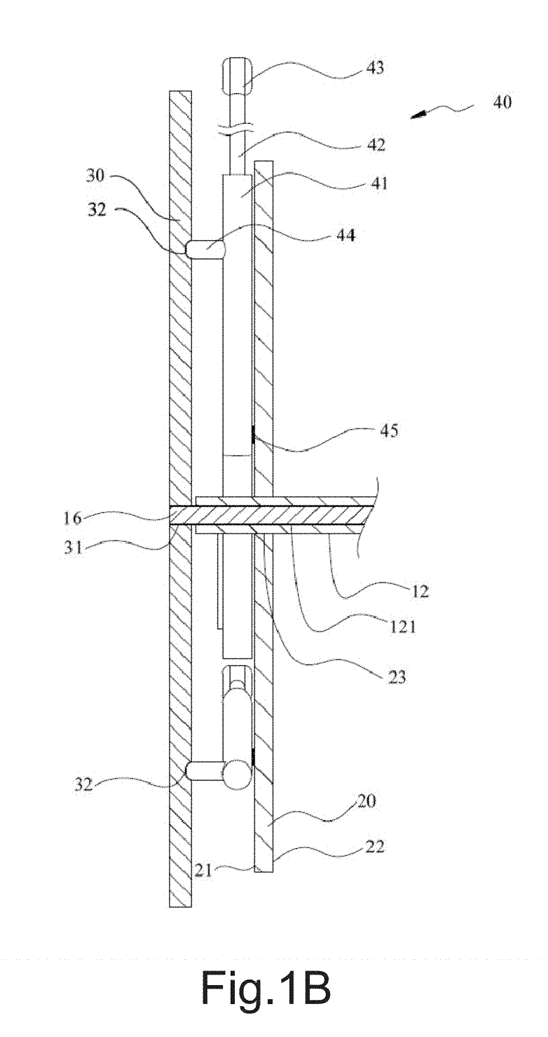

FIG. 1A is a cross sectional view showing the operation of an intelligent clean energy generator according to a first embodiment of the present invention, and the intelligent clean energy generator comprises: a case 1, a body 10, a polygonal flywheel 20, a guide structure 30, and multiple inertial members 40.

The case 1 is mounted on a base (not shown) and accommodates the body. The body 10 includes an accommodation chamber 11 defined by an inner wall of the body 10, an eccentric shaft 12 housed in the accommodation chamber 11, and the guide structure 30 defined on the inner wall of the body 10. The guide structure 30 includes a guiding face 31 and a groove 32 formed on the guiding face 31, and the eccentric shaft 12 is retained in the guiding face 31, wherein the eccentric shaft 12 is a central post of an object (not shown) configured to drive the object, such as a power generator, a driven device, a vehicle, an air conditioning, a windmill, a spinning wheel, and an embryo machine, etc.

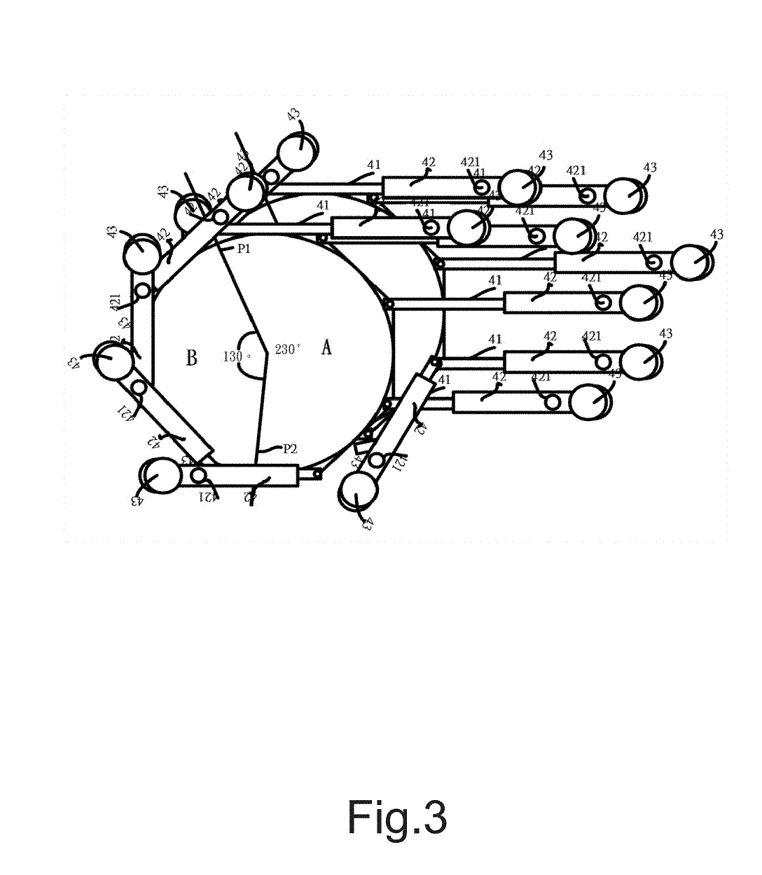

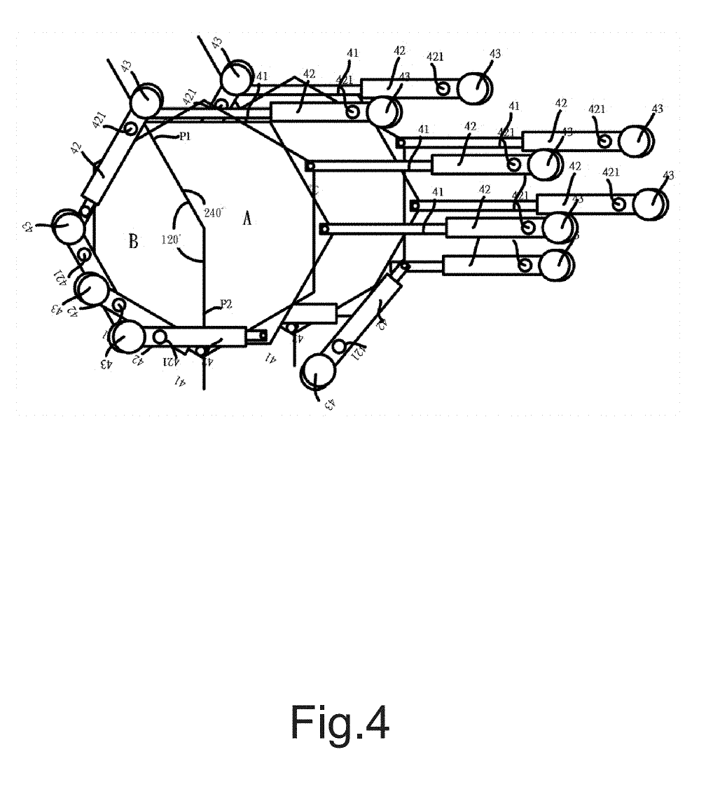

Referring to FIGS. 3 to 4, the eccentric shaft 12 is connected with the polygonal flywheel 20 housed in the accommodation chamber 11, and the polygonal flywheel 20 includes a first face 21, a second face 22, and a first through orifice 23 passing through the first face 21 and the second face 22 and accommodating the eccentric shaft 12. Preferably, the first face 21 of the polygonal flywheel 20 has multiple openings (not shown), and the polygonal flywheel 20 is in any one of geometric shapes, wherein a using angle of the geometric shapes is over 180 degrees (for example, when the polygonal flywheel is in an octagon shape, a using range is 230 degrees, and when the polygonal flywheel is in a hexagon shape, the using angle is 240 degrees).

As shown in FIGS. 1A to 4, the guide structure 30 is defined in the accommodation chamber 11. Substantially, the guide structure 30 is a hold plate on which a second through orifice 31 is defined. The body 10 includes a fixing post 16 inserting into the second through orifice 31 of the guide structure 30. Preferably, the eccentric shaft 12 has a third through orifice 121 formed thereon so that the fixing post 16 inserts into the second through orifice 31 of the guide structure 30 via the third through orifice 121. When the polygonal flywheel 20 drives the eccentric shaft 12 to rotate, the fixing post 16 does not revolve, and the guide structure 30 does not revolve to the polygonal flywheel 20. The guide structure 30 includes the groove 32 formed on one surface thereof facing the polygonal flywheel 20, and the groove 32 extends across an energy release zone A and an energy storage zone B around the eccentric shaft 12.

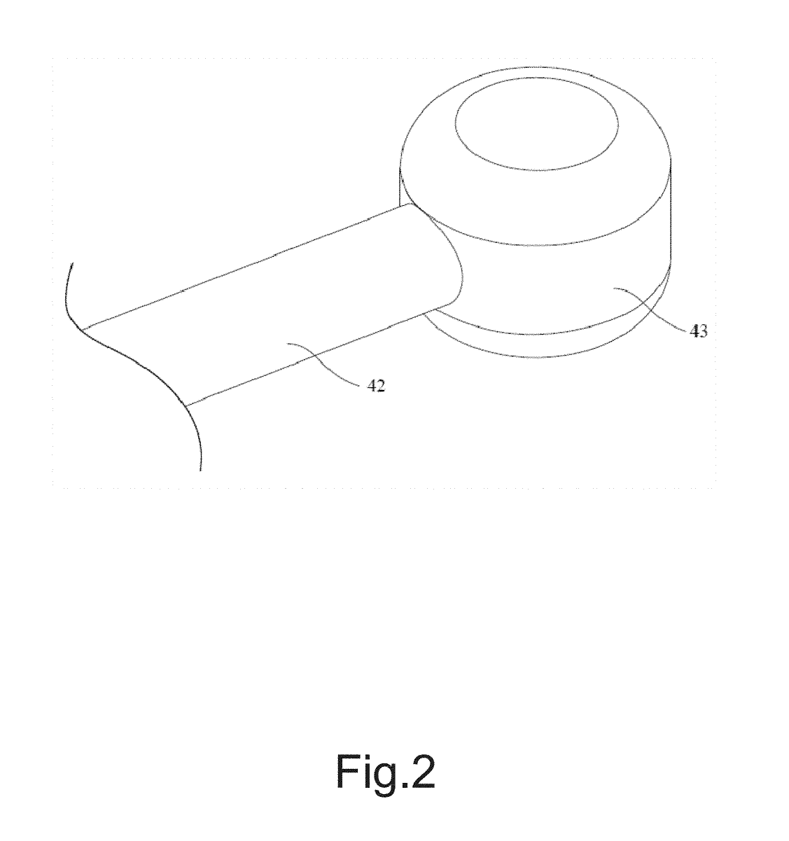

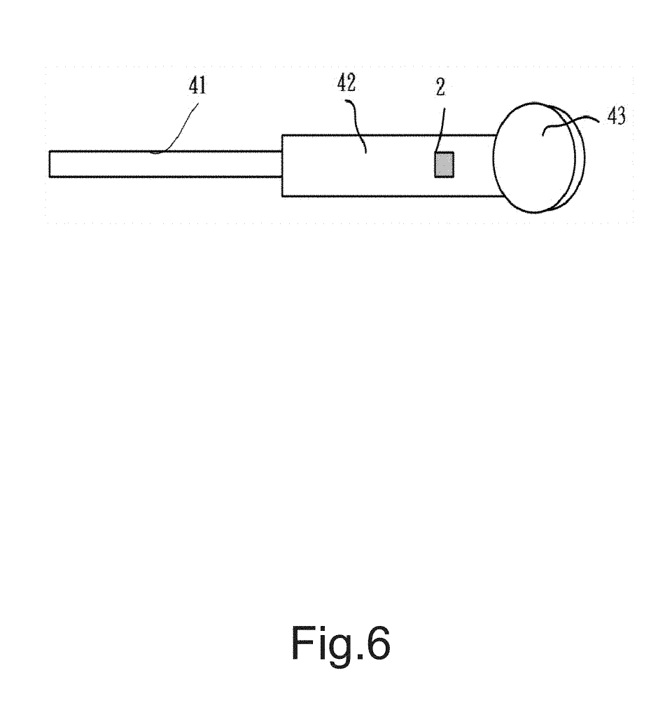

As illustrated in FIGS. 3 to 6, each of the multiple inertial members 40 includes a seat 41, a slide rod 42, and a counterweight block 43. The seat 41 is movably arranged on the first face 21 of the polygonal flywheel 20, and a fourth through orifice (not shown) is defined on the seat 41 and the guide structure 30. The slide rod 42 is slidably fixed between the seat 41 and the body 10. The counterweight block 43 is disposed on an end of the slide rod 42 and an outer diameter of the counterweight block 43 is more than an inner diameter of the fourth through orifice, wherein the counterweight block 43 exposes outside the fourth through orifice. Referring to FIGS. 1A, 1B, and 2, in the first embodiment, each inertial member 40 further includes a coupling bolt 44 and a rotation stein 45, the seat 41 has a first aperture (not shown) defined on a top thereof and has a second aperture (not shown) formed on a bottom of the seat 41, wherein the coupling bolt 44 is accommodated in the first aperture of the seat 41 and moves along the groove 32. The rotation stein 45 is rotatably connected with one of holes of the second aperture.

With reference to FIGS. 1B to 6, the seat 41 and the slide rod 42 of each inertial member 40 are square so as to reinforce each inertial member 40, and a diameter of the seat 41 is less than that of the slide rod 42 so as to increase torque, thus driving the intelligent clean energy generator easily.

As shown in FIGS. 1B to 6, the seat 41 of each inertial member 40 and the rotation stein 45 are movably mounted on each of corners of the polygonal flywheel 20, and the coupling bolt 44 is retained in the groove 32 of the guide structure 30. Since a distance between the rotation stein 45 and the coupling bolt 44 of each inertial member 40 is identical fixedly and the groove 32 of the coupling bolt 32 is arcuate, when each inertial member 40 runs along the groove 32, an angle between each inertial member 40 and a ground is 90 degrees.

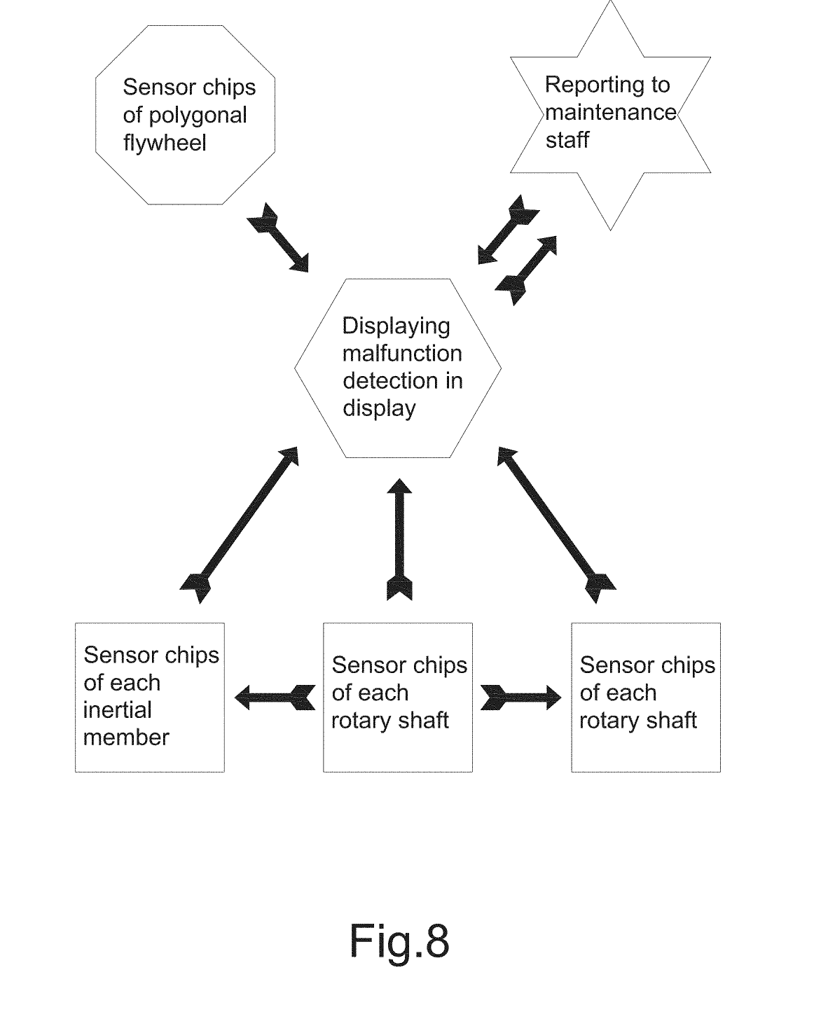

As illustrated in FIG. 8, the intelligent clean energy generator is safe, detects malfunction, and makes warming. The intelligent clean energy generator senses each inertial member 40 and malfunction of related components by way of infrared ray, thermal effect, noise, vibration, and sensor chips, and a LCD display displays a sensing result. Alternatively, the sensing result is reported automatically. For example, before the rotation stein 45 is broken, it makes noises, vibrates, and heats so that the sensor chip detects abnormal signals and the abnormal signals are displayed on the LCD display. Thereafter, the abnormal signals are transmitted to a maintenance staff. Because the multiple inertial members 40 have serial numbers respectively, the abnormal signals of the multiple inertial members 40 are displayed on the LCD display by their serial numbers respectively and are reported to the maintenance staff so as to solve the malfunction in a short time.

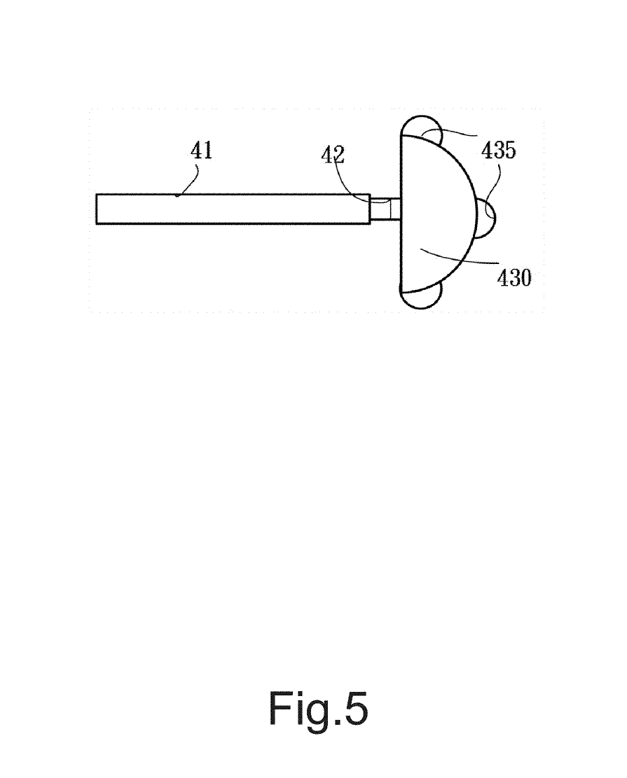

As illustrated in FIG. 5, a heavy duty clean energy generator 430 is designed based on a relationship among lever, weight and torque, wherein the heavier a distal end of the lever is, the greater torque is so as to produce a forceful drive force. Preferably, the heavy duty clean energy generator 430 is employed, when the counterweight block 43 is not applicable for magnetic energy.

With reference to FIGS. 3 to 4, in a second embodiment, when each inertial member 40 rotates to a predetermined position of the energy release zone A (for example, the slide rod 42 retracts into the seat 41 and the counterweight block 43 is perpendicular to the bottom of the case 4), the energy release zone A bends to the energy storage zone B in heavy acceleration, hence a terminal position of releasing energy is identical to a starting position of storing energy. A plurality of polygonal flywheels are connected serially so as to release energy in high efficiency.

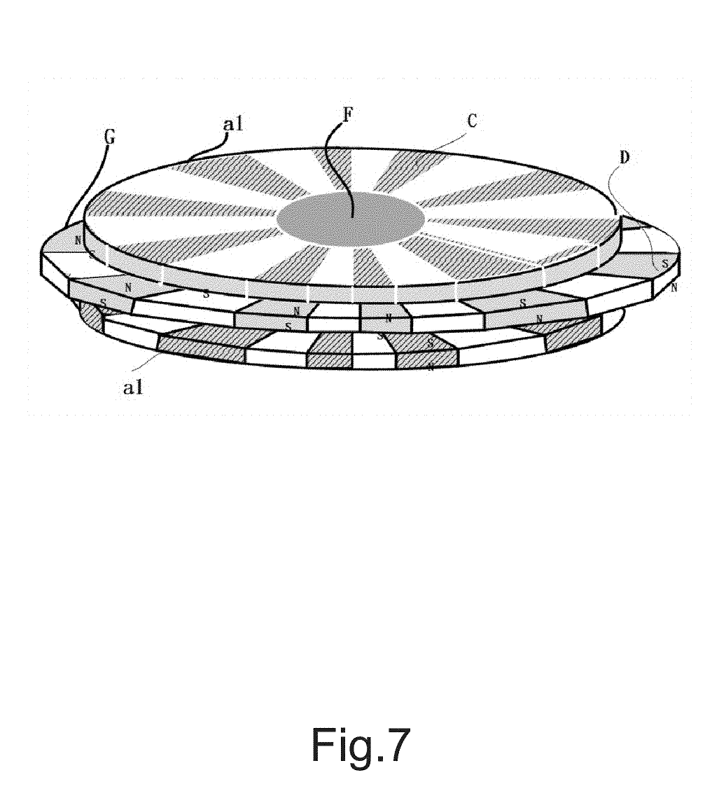

With reference to FIG. 7, a magnetic disc replaces the counterweight block 43, wherein the magnetic disc has two stators a1, two coil sets C are arranged on the two stators a1 respectively, and the rotator G and a magnet D are defined between the two stators a1 so that when the rotator G and the magnet D revolve, two coil sets C of the two stators a1 produce double electricity.

A speed of the intelligent clean energy generator is related to a vector angle between the polygonal flywheel 20 and the ground, wherein when the vector angle between the polygonal flywheel 20 and the ground is proportional, a torque of the polygonal wheel 20 is largest and a speed of the polygonal wheel 20 is fastest at 90 degrees. When the polygonal flywheel 20 is parallel to the ground, the torque of the polygonal wheel 20 is zero and the speed of the polygonal wheel 20 is zero. Accordingly, a speed of the intelligent clean energy generator is controlled by the vector angle between the polygonal flywheel 20 and the ground.

In a third embodiment, an intelligent clean energy generator comprises a plurality of polygonal flywheels 20, and an eccentric shaft 12 inserts through multiple first through orifices of the plurality of polygonal flywheels 20. Preferably, forces of the plurality of polygonal flywheels 20 exerting on the eccentric shaft 12 are greater than a force of a single polygonal flywheel 20 exerting on the eccentric shaft 12. Thereby, a rotating speed of the eccentric shaft 12 of the third embodiment is faster than that of the first embodiment, and the eccentric shaft 12 of the third embodiment is used as a central post of the power generator.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An intelligent clean energy generator comprising:
a case mounted on a base and accommodating a body, the body including an accommodation chamber defined by an inner wall of the body, an eccentric shaft housed in the accommodation chamber, wherein a guide structure is defined in the accommodation chamber of the body, the guide structure includes a guiding face and a groove formed on the guiding face and configured to guide a rotation stein; and the eccentric shaft is fixed in the accommodation chamber of the body, at least one flywheel is connected on the eccentric shaft, and each of the at least one flywheel includes multiple inertial members arranged thereon, wherein the multiple inertial members are movably arranged on corners of each flywheel; each of the multiple inertial members has a seat, a coupling bolt and the rotation stein which are connected on the seat, wherein a distance between the rotation stein and the coupling bolt of each inertial member is identical fixedly so that each inertial member is perpendicular to a horizon; the seat has a slide rod on which a counterweight block is disposed; the accommodation chamber of the body accommodates a power generator connecting with the eccentric shaft; each flywheel is polygonal, and the rotation stein of each inertial member is movably arranged on each of the corners of each flywheel so as to match with an energy release zone.

2. The intelligent clean energy generator as claimed in claim 1, wherein an angle of the energy release zone is inversely proportional to a number of peripheral sides of each flywheel, and when the number of the peripheral sides of each flywheel increases, a using angle increases, wherein the angle of the energy release zone is over 180 degrees, when each flywheel is in an octagon shape, the using angle is 230 degrees, and when each flywheel is in a hexagon shape, the using angle is 240 degrees.

3. The intelligent clean energy generator as claimed in claim 1, wherein each flywheel is a polygonal flywheel.

4. The intelligent clean energy generator as claimed in claim 1, wherein each flywheel includes the multiple inertial members arranged thereon, and angles of the multiple inertial members are identical to those of the at least one flywheel, wherein the multiple inertial members are movably arranged on the corners of each flywheel.

5. The intelligent clean energy generator as claimed in claim 1, wherein the seat and the slide rod of each inertial member are square, and a diameter of the seat is less than that of the slide rod.

6. The intelligent clean energy generator as claimed in claim 1, wherein the counterweight block is a magnetic energy generator or is heavy duty.

7. The intelligent clean energy generator as claimed in claim 1, wherein the seat has the coupling bolt and the rotation stein, and the distance between the rotation stein and the coupling bolt of the seat is fixed so that each inertial member is perpendicular to a ground at 90 degrees when each inertial member runs along the groove.

8. The intelligent clean energy generator as claimed in claim 1, wherein the at least one flywheel is serially connected.

9. The intelligent clean energy generator as claimed in claim 1, wherein components of the intelligent clean energy generator have sensor chips, indication, alert, and report systems respectively.

10. The intelligent clean energy generator as claimed in claim 1, wherein the intelligent clean energy generator is started and operates by way of weight, force, and torque.
